(19) United States
(12) Patent Application Publication
(10) Pub. No.: US 2016/0150454 A1
(43) Pub. Date: May 26, 2016

(54) CLIENT MANAGED SOFT HANDOVER AND SEAMLESS LINK FAILOVER FOR WIRELESS NETWORKS

(71) Applicant: Laird Technologies, Inc., Earth City, MO (US)

(72) Inventors: Daniel B. Kephart, JR., Cuyahoga Falls, OH (US); Andrew Dobbing, Aylesbury (GB); Kris A. Sidle, Macedonia, OH (US); Jeffrey R. Adams, Louisville, OH (US)

(21) Appl. No.: 14/591,798

(22) Filed: Jan. 7, 2015

Related U.S. Application Data
(60) Provisional application No. 62/083,445, filed on Nov. 24, 2014.

(51) Int. Cl. H04W 36/18

(52) U.S. Cl. CPC H04W 36/18

(57) ABSTRACT

According to various aspects, exemplary embodiments are disclosed of systems and methods related to client managed soft handover and seamless link failover for wireless networks. In an exemplary embodiment, a wireless client includes a primary interface and a secondary interface. The primary interface is configured to connect to a wireless network via a first wireless network connection. The secondary interface is configured to connect to the wireless network via a second wireless network connection. The wireless client also includes a controller configured to maintain the first wireless network connection via the primary interface and the second network connection via the secondary interface substantially simultaneously.

### CROSS-REFERENCE TO RELATED APPLICATION

This application claims the benefit of and priority to U.S. Provisional Application No. 62/083,445 filed Nov. 24, 2014. The entire disclosure of the above application is incorporated herein by reference.

### FIELD

The present disclosure generally relates to systems and methods for client managed soft handover and seamless link failover for wireless networks.

### BACKGROUND

This section provides background information related to the present disclosure which is not necessarily prior art.

Wireless networks may be deployed in locations and may have more than one wireless network access point. Wireless clients may evaluate and track signals from access points (APs) in order to find the best AP to choose when it is time for the wireless client to roam.

Some wireless clients may maintain a connection to only one access point. When the wireless client decides to roam to a new AP, the wireless client may terminate its connection to the previous access point and then establish a connection to the new access point.

### SUMMARY

This section provides a general summary of the disclosure, and is not a comprehensive disclosure of its full scope or all of its features.

According to various aspects, exemplary embodiments are disclosed of systems and methods related to client managed soft handover and seamless link failover for wireless networks. In an exemplary embodiment, a wireless client includes a primary interface and a secondary interface. The primary interface is configured to connect to a wireless network via a first wireless network connection. The secondary interface is configured to connect to the wireless network via a second wireless network connection. The wireless client also includes a controller configured to maintain the first wireless network connection via the primary interface and the second network connection via the secondary interface substantially simultaneously.

In another exemplary embodiment, a network device includes a network interface. The network interface is configured to receive a first network connection from a primary interface of a wireless client and a second network connection from a secondary interface of the wireless client. The network device also includes a controller configured to maintain the first network connection and the second wireless connection substantially simultaneously.

In a further exemplary embodiment, a method of maintaining multiple wireless connections between a wireless client and a wireless network generally includes establishing a first wireless connection to a wireless network via a primary interface of a wireless client, establishing a second wireless connection to the wireless network via a secondary interface of the wireless client, and maintaining the first wireless connection via the primary interface and the second wireless connection via the secondary interface substantially simultaneously.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of a wireless network system according to an aspect of the present disclosure;

FIG. 2 is another block diagram of the example system of FIG. 1;

FIG. 3 is a flowchart of an example method of transmitting data packets from a wireless client according to another aspect of the present disclosure;

FIG. 4 is a flowchart of an example method of receiving data packets at a network device according to another aspect of the present disclosure;

FIG. 5 is a flowchart of an example method of transmitting data packets from a wireless network device according to another aspect of the present disclosure;

FIG. 6A is an example look-up table of a network device according to another aspect of the present disclosure; and

FIG. 6B is an example look-up table of a wireless client according to another aspect of the present disclosure.

### DETAILED DESCRIPTION

Example embodiments will now be described more fully with reference to the accompanying drawings.

The inventor has recognized that some implementations which allow a wireless client to maintain multiple connections to a single wireless network require the wireless network infrastructure to be aware the wireless client is maintaining both a first connection and a new connection. Otherwise, the wireless client may be kicked off the first connection when it attempts the new connection.

The inventor has also recognized a wireless network infrastructure needs to know where to route network packets. When a wireless client (e.g., a WiFi client, etc.) establishes a connection to a new access point (AP), the new infrastructure will automatically deliver packets to the new AP. If both the first connection and the new connection are maintained, then the wireless network infrastructure needs some kind of mechanism to decide whether it is better to route the data packets to the old AP or the new AP. The working assumption with WiFi roaming is that the wireless client would not request to connect to the new AP unless the client decided the new AP was going to be a more reliable connection. Therefore, the infrastructure defaults to sending packets to the new AP and disconnects the client from the old AP to ensure there is no confusion.

Disclosed herein are exemplary embodiments of systems and methods related to client managed soft handover and seamless link failover for wireless networks (e.g., WiFi networks, etc.). In an example embodiment, a wireless client includes a primary and secondary interfaces (e.g., wireless radios, etc.). The primary interface is configured to connect to a wireless network via a first wireless network connection. The secondary interface is configured to connect to the wireless network via a second wireless network connection. The wireless client also includes a controller configured to maintain the first wireless network connection via the primary interface and the second network connection via the secondary interface substantially simultaneously.

In some example embodiments, the WiFi client may establish a connection to a first AP and then to a new AP, maintain both the connection to the first AP and to the new AP, and then disconnect from the first AP when it deems the new connection reliable. This may ensure more reliable roaming and allow the WiFi client to fall back to the first AP if the new AP's connection is bad. Each connection may appear to the WiFi infrastructure as a separate client, and may be seamless to the device using the WiFi client. This may allow the WiFi client to roam faster and more reliably. Only the WiFi client may manage the connections while the WiFi infrastructure sees two different WiFi clients.

In some example embodiments, two normal separate WiFi connections may be used from the physical and data link layers point of view, as opposed to having the physical and data link layers on the client and network infrastructure manage the details of a soft handover and obfuscation of having two connections while an application only sees one connection. In these example embodiments, software at the network and transport layer on the wireless client may register with a server and/or a receiving device that it will be sending packets to on both connections. This software on the client may also make it appear to an application layer that there is only one connection. The wireless client can then send packets out of both connections from an application that only sees one connection. The server or receiving device may then make the client's packets appear as if they are only coming from one connection to applications running on the receiving device. In some embodiments, the wireless network infrastructure (e.g., base stations, core network, wireless access points, etc.) may not be required to be aware that two connections are being used as one from an application's point of view.

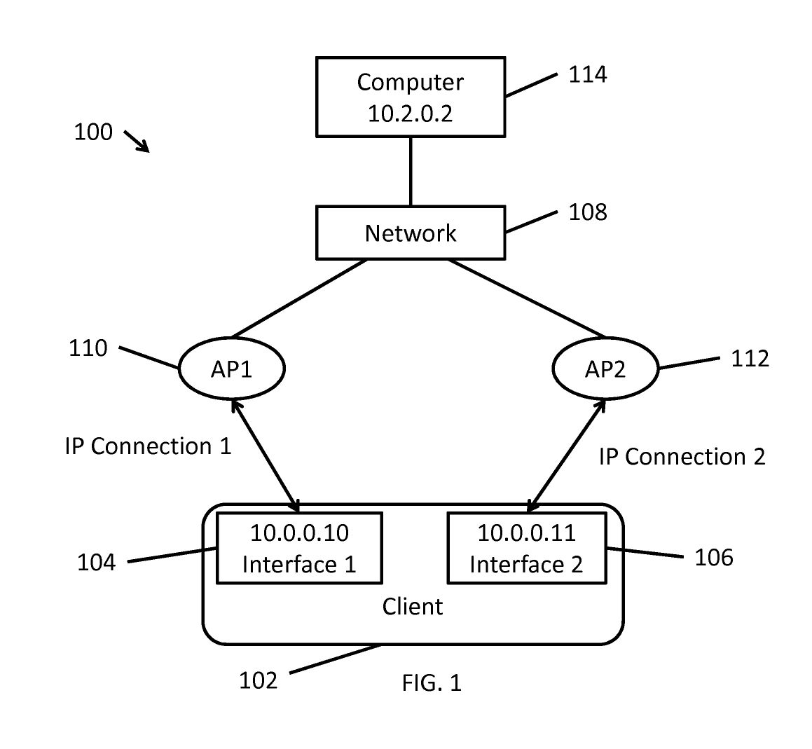

With reference to the figures, FIG. 1 illustrates an example system 100 according to some aspects of the present disclosure. The system 100 includes a wireless client 102 having a primary interface 104 and a secondary interface 106. The wireless network 108 includes a first access point 110 and a second access point 112. The network is also coupled to a computer 114. The primary interface 104 is coupled to the first access point 110 via a first wireless network connection (IP Connection 1) and the secondary interface 106 is coupled to the second access point 112 via a second wireless network connection (IP Connection 2).

The wireless client 102 may be any suitable device capable of establishing a wireless connection with the network 108, including a laptop computer, desktop computer, tablet, smartphone, WiFi client, wireless medical device, wireless equipped vehicle, etc. The primary interface 104 and secondary interface 106 may by any suitable interfaces capable of transmitting and receiving data packets via a wireless network connection, including WiFi radios, etc. As shown in FIG. 1, the primary interface may include a first IP address, and the secondary interface may include a second IP address that is different than the first IP address. In this example, the first IP address is illustrated as 10.0.0.10, while the second IP address is illustrated as 10.0.011.

The wireless network 108 may be any suitable wireless network cable of transmitting wireless signals between devices, including a WiFi network, local area network (LAN), wide area network (WAN), cellular network, etc. The access points 110 and 112 may be any suitable devices capable of relaying messages in the wireless network, including routers, WiFi devices, etc. The computer 114 may be any suitable computer capable of connecting to the network 108, including a server, laptop computer, desktop computer, tablet, smartphone, etc. Although the system 100 shown in FIG. 1 includes a network 108 having two access points 110 and 112 that establish wireless connections via internet protocol (IP) connections and a single connected computer 114, other embodiments may include more access points, more connected computers, use different connection protocols, etc.

According to some exemplary embodiments, wireless client 102 may be a soft handover WiFi client that may use two WiFi interfaces to make two separate connections to the WiFi infrastructure. The different WiFi interfaces could be two physically different WiFi radios, a single physical WiFi radio that has two virtual WiFi interfaces to the WiFi network, etc. Each WiFi interface could maintain its own connection with separate IP addresses to a WiFi access point. One WiFi interface would be considered the primary interface. The soft handover feature may only be used when communicating to devices that support the soft handover stack (e.g., supported devices, etc.).

In order to establish that a device is a supported device, a discovery sequence between the WiFi client and a supported device could be performed. This discovery sequence may be initiated when an application attempts to establish an IP connection to a new IP address not known to be a supported device or a non-supported device. If the discovery sequence succeeds, then the soft handover stack on the WiFi client could register its two IP addresses with the soft handover stack on the supported device. It may also register which IP address belongs to the primary interface. On the WiFi client, the IP address of the supported device may be saved in a table of supported devices.

A central registration application may be used to assist with registration of IP addresses for supported devices. This central registration application may be run on a server connected to the wireless network. When using a registration application, all supported devices may register their IP addresses with the registration application. When a WiFi client connects to the wireless network, it may retrieve the list of supported devices and their IP addresses. The WiFi client could then register the IP addresses of each of its interfaces with the registration server, and also which interface is a primary interface. Once this registration is complete, the registration server may update all supported devices with the WiFi client's registration information.

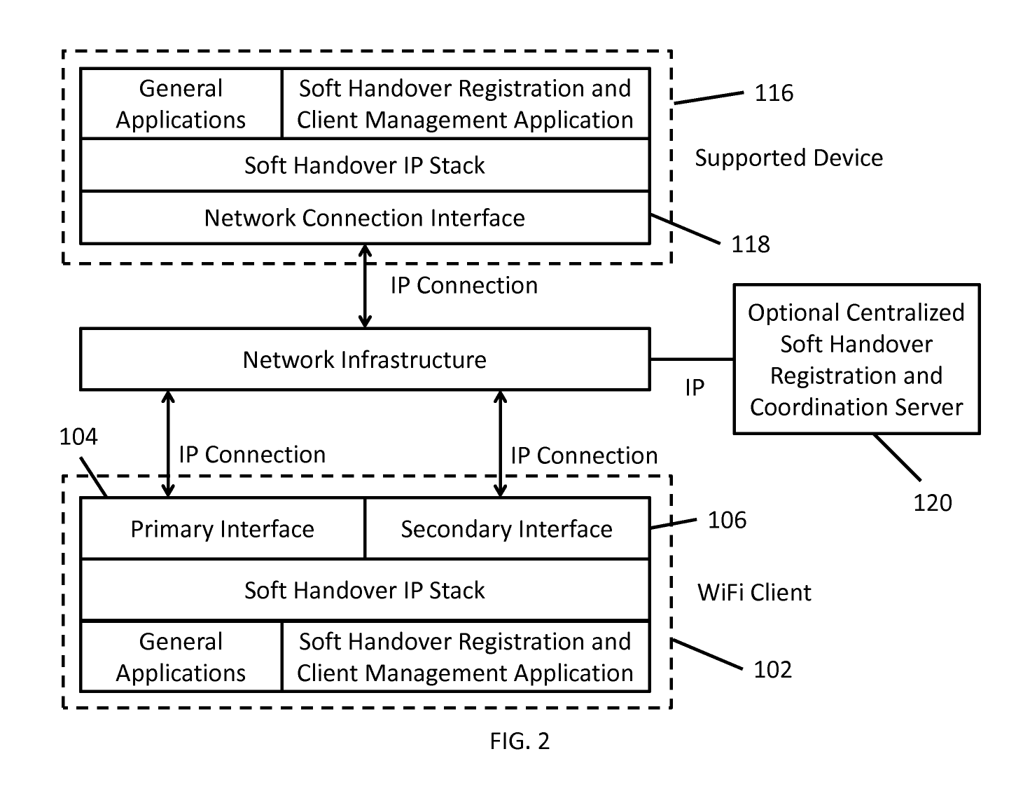

FIG. 2 illustrates an example block diagram of some components of the system 100 of FIG. 1. For example, the WiFi client 102 includes a primary interface 104 and a secondary interface 106 each having an IP connection to the network infrastructure (which may include access points, network devices, etc.). The WiFi client 102 includes a soft handover IP stack configured to manage transmitting and receiving data packets from the network. The WiFi client 102 includes general applications, which may communicate with the network on an occasional, regular, continuous, etc. basis. The WiFi client 102 also includes a soft handover registration and client management application, which may be configured to control the use of primary and secondary interfaces 104, 106 and handle communication between those interfaces and general applications.

Supported device 116 includes a network connection 118 which is configured to connect to the network infrastructure via an IP connection. The supported device 116 also includes a soft handover IP stack, general applications, and a soft handover registration and client management application. There may also be an optional server 120 configured for centralized soft handover registration and coordination.

In some embodiments, when a WiFi client is communicating with a supported device (e.g., a device capable of maintaining and/or interpreting separate connections from a primary and secondary interface of the WiFi client, etc.), packets could be sent and received from either the primary or the secondary interface. When the WiFi client communicates with devices not running the soft handover stack (e.g., non-supported devices, etc.), only the primary interface may be used. The WiFi client could thus communicate with supported and non-supported devices substantially simultaneously.

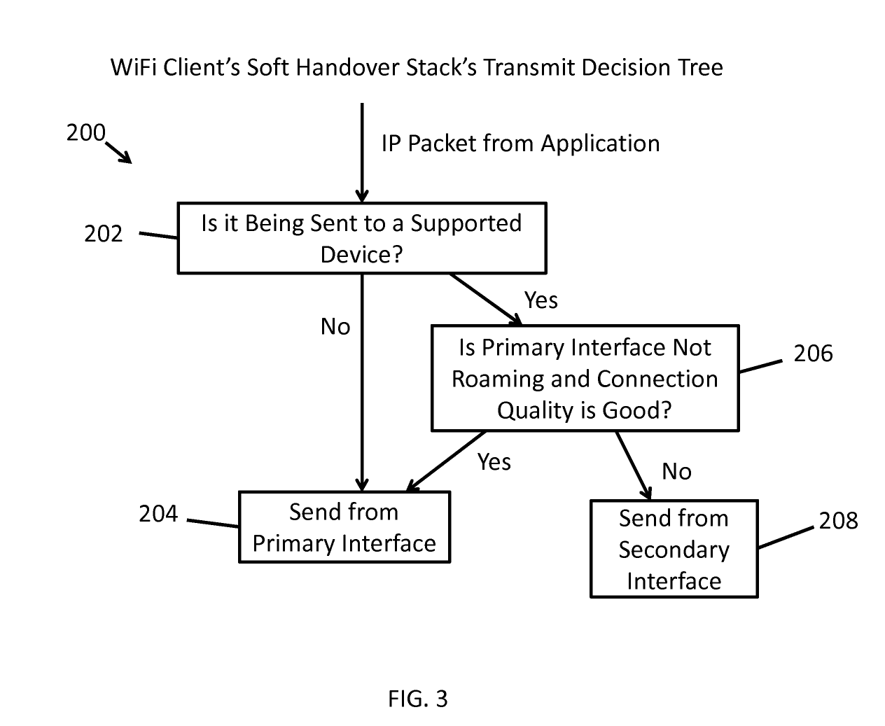

FIG. 3 illustrates an example method 200 for determining how to transmit data packets from a WiFi client. At 202, the WiFi client receives an IP packet from a general application and determines whether it is being sent to a supported device. If the packet is not being sent to a supported device, the packet is transmitted from the primary interface, at 204. If the packet is being sent to a supported device, the WiFi client determines, at 206, whether the primary interface is not roaming and the connection quality is good. If the primary interface is not roaming and the connection quality is good, the packet is transmitted from the primary interface at 204. If the primary interface is roaming and/or the connection quality is not good, the packet is sent from the secondary interface at 208.

In some example embodiments, the soft handover stack on the WiFi client could be responsible for determining if a destination IP address on a transmitting packet belongs to a supported or non-supported device, and determine which interface to send out packets from. Packets could be sent out on the primary interface by default, unless the soft handover stack is informed of poor connection quality on the primary interface or that the primary interface is in a roaming state. In that case, the source address could be changed to the secondary interface's IP address and sent out from the secondary interface. Applications on the WiFi client may only see the IP address of the primary interface and have no knowledge of the secondary interface. When IP packets from a supported device are received on the secondary interface, the soft handover stack may change the destination IP address to the primary interface and put the packet through to the application from the primary interface. Packets received on the primary interface may be processed normally. Thus, the applications on the WiFi client may communicate as if there is only one WiFi interface with one IP address.

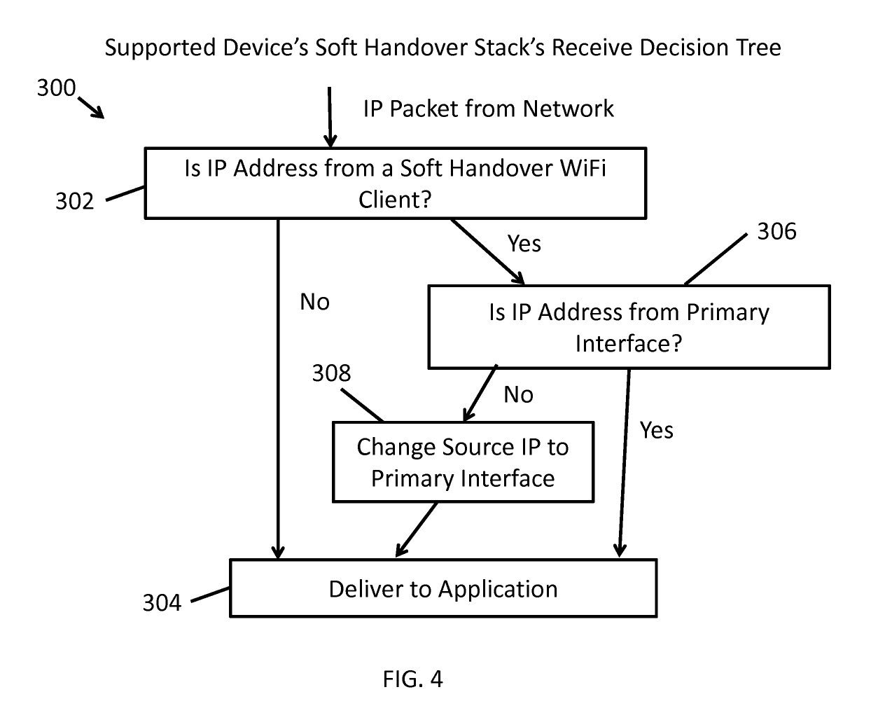

FIG. 4 illustrates an example method 300 for determining how to handle received data packets at a supported device (e.g., a network device, etc.) from a WiFi client. At 302, the network device determines whether the IP address of the packet is from a soft handover WiFi client. If not, the packet is delivered to an application at 304. If the IP address of the received packet is from a soft handover WiFi client, the network device determines, at 306, whether the IP address is from the primary interface of the WiFi client. If yes, the network device delivers the packet to the application at 304. If the IP address is not from the primary interface of the WiFi client, the network device changes the source IP address of the packet to the primary interface at 308 before delivering the packet to the application at 304.

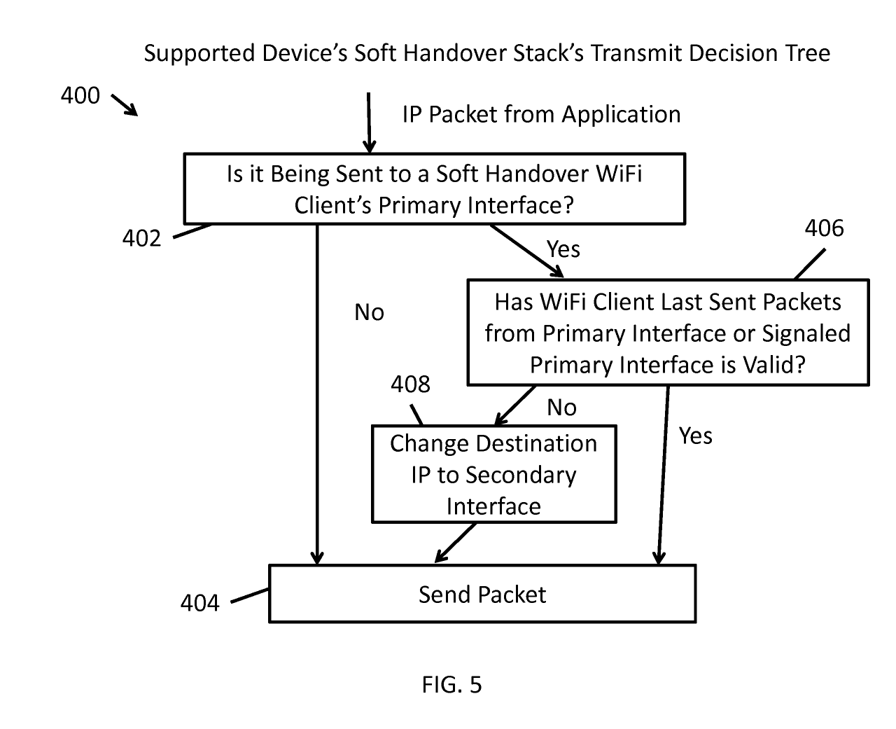

FIG. 5 illustrates an example method 400 for determining how to transmit data packets from a supported device (e.g., a network device, etc.) to a WiFi client. At 402, the network device determines whether the IP packet is being sent to the primary interface of a soft handover WiFi client. If not, the packet is sent at 404. If the packet is being sent to the primary interface of a soft handover WiFi client, the network device determines, at 406, whether the WiFi client last sent packets from its primary interface and/or signaled that the primary interface is valid. If yes, the network device sends the packet at 404. If the WiFi client did not last send packets from its primary interface and/or did not signal the primary interface is valid, the network device changes the destination IP address of the packet to the secondary interface at 408 before sending the IP packet at 404.

In some example embodiments, the soft handover stack on a supported device may be responsible for determining if a source IP address on a received packet belongs to a WiFi client supporting soft handover. If the source IP address belongs to a soft handover WiFi client, then if the packet is received from the primary interface it may be processed and delivered to an application normally. If the packet was received from the WiFi client's secondary interface, the source IP address may be changed to the WiFi client's primary interface, and then the packet may be delivered to the application.

When transmitting packets to a WiFi client that supports soft handover, the destination IP address may be changed to the secondary interface's IP address if the supported device last received a packet from the secondary interface of the WiFi client and/or the WiFi client has signaled to the supported device to send packets to the secondary interface. The supported device may resume transmission to the primary interface when signaled by the WiFi client and/or if the last received packet from the WiFi client was from the primary interface.

In some example embodiments, the WiFi client may switch interfaces during link failover, even when not attempting to roam. For example, if the primary interface's link fails for any reason, the WiFi client may fall back on the secondary interface.

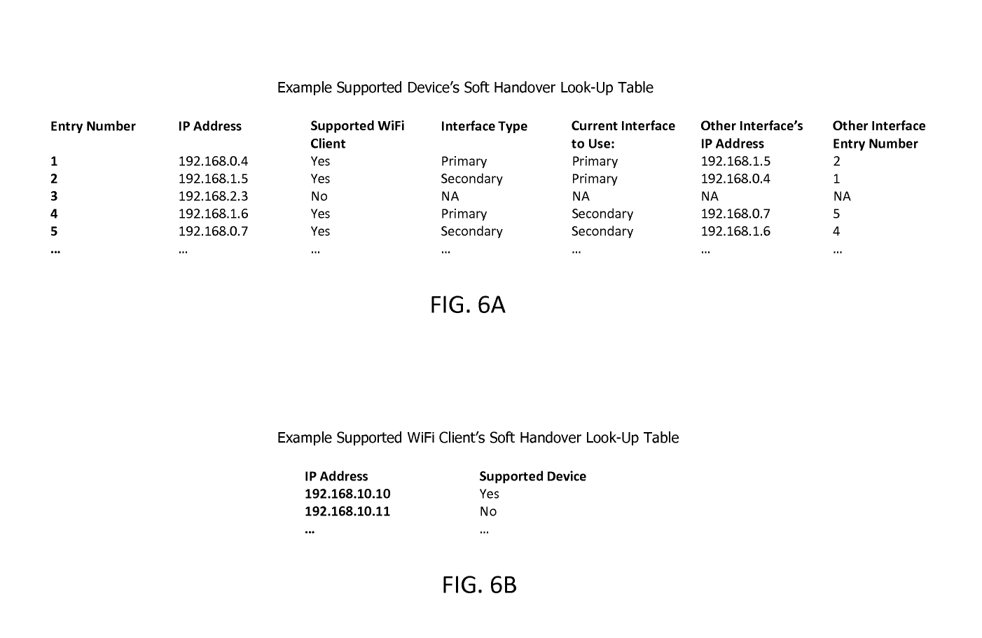

FIG. 6A illustrates an example of a supported device's soft handover look-up table. The table includes a column for each entry number, a column for the IP address associated with each entry number, a column indicating whether the IP address belongs to a WiFi client that supports soft handover, a column indicating the interface type for the entry number, a column indicting which current interface should be used for transmission of data packets for the entry number, a column for the IP address of the other interface for the entry number, and a column for the entry number of the other interface. This table allows the supported device to track information for each wireless connection based on IP addresses. The table allows the supported device to determine whether each connection belongs to a supported WiFi client. If the connection belongs to a supported WiFi client, the table allows the supported device to determine whether the connection is the primary or secondary interface, which interface should be used currently for communication with the WiFi client, and information regarding the corresponding interface (e.g., the other interface's IP address, entry number in the table, etc.).

FIG. 6B illustrates an example of a WiFi client's soft handover look-up table. The table includes an IP address of each device for which the WiFi client has a wireless connection. The table also indicates whether the IP address belongs to a supported device. Therefore, the WiFi client can determine whether it is communicating with a supported device capable of maintaining and interpreting a primary interface connection and a secondary interface connection.

In some example embodiments, a WiFi client's initial connection model when there is no central registration may include connecting with an access point on the WiFi infrastructure via the primary interface. The WiFi client's secondary interface then connects with a different access point on the WiFi infrastructure. If the secondary interface cannot find another good access point, it could connect to a different band on the same access point as the primary interface. If neither are options, it could connect to a different channel in the same band on the same access point. If all of the aforementioned are not available, it could resort to connecting to the same access point on the same channel as the primary interface. If the soft handover stack has been preconfigured with known supported devices and/or has a list from previous connections, it may register the IP addresses of its primary and secondary interfaces with each known supported device, along with which IP address is the primary interface. Otherwise the WiFi client waits for an application on the WiFi client to establish an IP connection with another device, or for another device to connect to an application on the WiFi client. The connection would go over the primary interface. The soft handover software stack on the WiFi client then detects the IP connection and attempts to discover if the device is a supported device. If the device is a supported device, the WiFi client registers the primary interface and secondary interface IP addresses with the supported device, along with which IP address is the primary interface.

In some example embodiments, a supported wireless device's initial connection mode when there is no central registration may include determining whether the device has a soft handover stack that has been preconfigured with known soft handover WiFi clients and/or has a list from previous connections. If so, the WiFi client may register the IP address of its primary interface and its secondary interface, along with which IP address is the primary interface. This may be done for each known soft handover capable WiFi client. If the wireless device does not have a preconfigured and/or developed list of soft handover WiFi clients, the supported wireless device may wait until an application on the supported device opens an IP connection with another device, at which point the soft handover stack may attempt to discover if the other device is a WiFi client with a soft handover stack. If so, the WiFi client may register the IP address of its primary interface and its secondary interface, along with which IP address is the primary interface.

Some example embodiments may include a central registration setup. In these example embodiments, a WiFi client initial connection model may include having supported devices register their IP addresses with a centralized soft handover registration application. A WiFi client's primary interface then connects with an access point on the WiFi infrastructure. The WiFi client's secondary interface then attempts to connect with a different access point on the WiFi infrastructure. If the secondary interface cannot find another good access point, the secondary interface could connect to a different band on the same access point as the primary interface. If neither are options, the secondary interface could connect to a different channel in the same band on the same access point. If all of the aforementioned are not available, the secondary interface could resort to connecting to the same access point on the same channel. The WiFi client's soft handover stack then registers both the primary interface and secondary interface's IP address along with which IP address is from the primary interface. The soft handover registration application then updates supported devices with the new WiFi client's registration information. The soft handover registration application then updates the WiFi client with the registered supported devices information. From then on, updating of supported devices and supported WiFi clients could be done through the central registration application.

According to another example embodiment, a network device (e.g., wired network device, wireless network device, etc.) may include a network interface (e.g., wired network interface, wireless network interface, etc.) configured to receive a first wireless network connection from a primary interface of a wireless client and a second wireless network connection from a secondary interface of the wireless client, and a controller configured to maintain the first wireless network connection and the second wireless network connection substantially simultaneously. The network device may not need a network interface to be wireless, because packets may be delivered over the network infrastructure to the network device such that a wired or wireless network interface on the network device may be used.

The controller may be configured to transmit packets to the primary interface of the wireless client when the most recent packets received from the wireless client were received from the primary interface and/or the wireless client has signaled the primary interface is valid. The controller may also be configured to transmit packets to the secondary interface of the wireless client when the most recent packets received from the wireless client were received from the secondary interface. The controller may further be configured to transmit packets to the secondary interface of the wireless client when the most recent packets received from the wireless client were received from the secondary interface, and may be configured to change a destination IP address to the primary interface before delivering a packet to an application when the packet is received from the secondary interface of the wireless client.

An exemplary method of maintaining multiple wireless connections between a wireless client and a wireless network includes establishing a first wireless connection to a wireless network via a primary interface of a wireless client, establishing a second wireless connection to the wireless network via a secondary interface of the wireless client, and maintaining the first wireless connection via the primary interface and the second wireless connection via the secondary interface substantially simultaneously.

The method may include determining whether a network device of the wireless network is a supported device capable of maintaining a connection to the primary interface and a connection to the secondary interface substantially simultaneously. The method may also include transmitting packets via the primary interface when the primary interface connection quality is sufficient for reliable transmission of packets, and transmitting packets via the secondary interface when the primary interface connection quality is insufficient for reliable transmission of packets. The method may further include registering the primary interface with a server having a central registration application, and registering the secondary interface with the server having the central registration application. Establishing the first wireless connection may include establishing a network connection with a first access point of the wireless network, and establishing the second wireless connection includes establishing a network connection with the second access point of the wireless network.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purposes of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A wireless client comprising:
a primary interface configured to connect to a wireless network via a first wireless network connection;
a secondary interface configured to connect to the wireless network via a second wireless network connection; and
a controller configured to maintain the first wireless network connection via the primary interface and the second network connection via the secondary interface substantially simultaneously.

2. The wireless client of claim 1, wherein:
the primary interface includes a first internet protocol (IP) address; and
the secondary interface includes a second IP address.

3. The wireless client of claim 2, wherein:
the wireless network includes at least two access points;
the primary interface is configured to connect to the wireless network via a first access point; and
the secondary interface is configured to connect to the wireless network via a second access point.

4. The wireless client of claim 2, wherein:
the wireless network includes at least one access point; and
the primary interface is configured to connect to the wireless network via the at least one access point on a first band and the secondary interface is configured to connect to the wireless network via the at least one access point on a second band; and/or
the primary interface is configured to connect to the wireless network via the at least one access point on a first channel and the secondary interface is configured to connect to the wireless network via the at least one access point on a second channel; and/or
the primary interface is configured to connect to the wireless network via the at least one access point on the first channel and the secondary interface is configured to connect to the wireless network via the at least one access point on the first channel.

5. The wireless client of claim 2, wherein:
the primary interface includes a first wireless radio and the secondary interface includes a second wireless radio that is physically separate from the first wireless radio; and/or
the primary interface includes a first virtual wireless interface of a single physical wireless radio and the secondary interface includes a second virtual wireless interface of the single physical wireless radio.

6. The wireless client of claim 1, wherein the controller is configured to, for each attempt to connect to a network device, determine whether the network device is a supported device capable of maintaining a connection to the primary interface and a connection to the secondary interface substantially simultaneously.

7. The wireless client of claim 6, wherein the controller is configured to, when it is determined the network device is not a supported device, connect to the network device via only the primary interface.

8. The wireless client of claim 1, wherein the controller is configured to register the primary interface with a server having a central registration application, and to register the secondary interface with the server having the central registration application.

9. The wireless client of claim 1, wherein the controller is configured to send packets via the primary interface when the primary interface connection quality is sufficient for reliable transmission of packets, and to send packets via the secondary interface when the primary interface connection quality is insufficient for reliable transmission of packets.

10. A network device comprising:
a network interface configured to receive a first network connection from a primary interface of a wireless client and a second network connection from a secondary interface of the wireless client; and
a controller configured to maintain the first network connection and the second network connection substantially simultaneously.

11. The network device of claim 10, wherein the controller is configured to transmit packets to the primary interface of the wireless client when the most recent packets received from the wireless client were received from the primary interface and/or the wireless client has signaled the primary interface is valid.

12. The network device of claim 11, wherein the controller is configured to transmit packets to the secondary interface of the wireless client when the most recent packets received from the wireless client were received from the secondary interface.

13. The network device of claim 12, wherein the controller is configured to change a destination internet protocol (IP) address of the packets to the secondary interface when the controller determines to transmit packets to the secondary interface.

14. The network device of claim 10, wherein the controller is configured to determine whether an unknown wireless client has a primary interface and secondary interface when the controller first receives packets from the unknown wireless client.

15. The network device of claim 10, wherein the controller is configured to change a source IP address to the primary interface before delivering a packet to an application when the packet is received from the secondary interface of the wireless client.

16. A method of maintaining multiple wireless connections between a wireless client and a network, the method comprising:
establishing a first wireless connection to a wireless network via a primary interface of a wireless client;
establishing a second wireless connection to the network via a secondary interface of the wireless client; and
maintaining the first wireless connection via the primary interface and the second wireless connection via the secondary interface substantially simultaneously.

17. The method of claim 16, further comprising determining whether a network device of the network is a supported device capable of maintaining a connection to the primary interface and a connection to the secondary interface substantially simultaneously.

18. The method of claim 16, further comprising:
transmitting packets via the primary interface when the primary interface connection quality is sufficient for reliable transmission of packets; and
transmitting packets via the secondary interface when the primary interface connection quality is insufficient for reliable transmission of packets.

19. The method of claim 16, further comprising:
registering the primary interface with a server having a central registration application; and
registering the secondary interface with the server having the central registration application.

20. The method of claim 16, wherein:
establishing the first wireless connection includes establishing a network connection with a first access point of the network and establishing the second wireless connection includes establishing a network connection with a second access point of the network; and/or
establishing the first wireless connection includes establishing a network connection with the first access point of the network on a first band and establishing the second wireless connection includes establishing a network connection with the first access point of the network on a second band; and/or
establishing the first wireless connection includes establishing a network connection with the first access point of the network on a first channel and establishing the second wireless connection includes establishing a network connection with the first access point of the network on a second channel; and/or
establishing the first wireless connection includes establishing a network connection with the first access point of the network on the first channel and establishing the second wireless connection includes establishing a network connection with the first access point of the network on the first channel.
